(19) United States
(12) Patent Application Publication
(10) Pub. No.: US 2006/0143891 A1
(43) Pub. Date: Jul. 6, 2006

(54) Spacing means and methods of use therefor

(76) Inventor: James M. Reesing, Cedar Park, TX (US)

Correspondence Address: Christopher J. Whewell;Western Patent Group, 6020 Tonkowa Trail, Georgetown, TX, 78628, US

(21) Appl. No.: 11/029,081

(22) Filed: Jan. 4, 2005

(51) Int. Cl. B25B 27/14

(52) U.S. Cl. 29/281.5

(57) ABSTRACT

Provided herein are spacing devices useful in aligning components of a wide variety of articles of manufacture during an assembly operation. Through use of a spacing device according to the invention, perfect alignment of components may be accomplished by a single workman. A spacing device according to the invention includes a guide portion which simultaneously and conveniently also serves as a handle for quick removal of the spacing device after an assembly operation. The present invention is useful in a wide range of end uses, including the alignment and assembly of components on motorized vehicles.

### TECHNICAL FIELD

This invention relates in general to the assembly of components on a finished article of manufacture. More particularly, it relates to alignment of components in a finished article such as an automobile, in a correct and desired position and/or location. Such components may include, without limitation, body panels and panes of glass.

### BACKGROUND

With the advent of the precision manufacture of highly-engineered articles including automobiles, trucks, boats, personal dwellings, office buildings, etc. over the course of the past century, there has been a general attendant increase in the precision with which the various component parts which make up such manufactures are fitted together and in relation to one another. To cite but one well-known example, the window panes used in the manufacture of automobiles are fitted to the vehicle by first applying an adhesive substance to a ledge disposed on the perimeter of the location of where the pane is to be mounted, and the pane is set in place thus enabling the adhesive substance to cure while the pane is in its desired position. Often, window panes are substantially rectangularly-shaped, and may be planar or may also comprise some degree of curvature, as is known in the art. In general, however, the opening into which a panel of glass is to be disposed on say, a passenger vehicle, needs to be larger than the pane itself to allow for variances in manufacture and thermal expansion of the vehicle components during temperature cycles which may be reasonably expected to be encountered by the vehicle. Thus, there is typically some gap between the edge of the window panel itself and the contour of the location in which it is to be disposed. At present, while manufacturing tolerances seem to be continuously decreasing, there nevertheless exists a visibly-noticeable variation in OEM window panel installations, with the gap between the edges of the window panel not being uniform around the entire perimeter of the installed window.

The same principles as aforedescribed concerning the alignment of automotive window glass is also applicable to other panel-type components of various manufactures, including body panels (such as fenders or quarter-panels) of automobiles. While, generally-speaking, OEM suppliers typically produce products which pass a high level of quality assurance testing, difficulties arise especially in the aftermarket area, where repairmen who do not have the benefit of access to OEM jigs, fixtures, and the like used in originally assembling articles of manufacture are called on to perform a repair operation, such as the replacing of a cracked windshield or otherwise defective panel of glass on an automobile. In such instances, the aftermarket repairman must prepare the receiving surface, apply the adhesive, and then position the window panel in place until the adhesive cures sufficiently. It is not uncommon during such an operation that the panel of glass either moves or is shifted such that it ends up being in an unacceptable position after the adhesive has cured, which oftentimes results in the necessity of having to re-perform the operation, sometimes with yet a further new piece of glass, as it is often impossible to remove glass panels without damaging them irreparably. Therefore, if a means were available to ensure proper positioning and maintenance of a window panel in a vehicle during the curing operation to the effect that the necessity to re-perform repair operations were eliminated, such a means would be readily accepted by industry. Further, if such means also included a means for assisting in guiding the piece to be positioned (e.g., a window or body panel), this would provide added benefit. If such a means were adaptable to many fitment procedures other than replacing windows, then a broad range of industries would be well served, and a great deal of time and materials would be saved, which would be of great benefit to consumers. The present invention provides such a means, and the satisfaction of these and other objects of the present invention will become apparent to one of ordinary skill after a thorough consideration of the remainder of the contents of this specification and the claims appended hereto.

### SUMMARY OF THE INVENTION

The present invention provides a portable device useful for providing uniform spacing between two or more components of an article of manufacture during an assembly process. A device according to the invention comprises: a) an anchoring portion having an first end portion and a second end portion; and b) a substantially linear functionalized portion. The functionalized portion comprises a i) a spacer end portion having a thickness dimension; and ii) a handle end portion. The first end portion of the anchoring portion is attached to the functionalized portion at a point along the functionalized portion which is disposed between the spacer end portion and the handle end portion, and wherein the second end portion of the anchoring portion includes a means for attachment of the anchoring portion to a substrate.

### BRIEF DESCRIPTION OF THE DRAWINGS

In the annexed drawings:

FIG. 1 shows a perspective view of a spacing device according to one form of the invention;

FIG. 2A shows a side view of a spacing device according to one form of the invention;

FIG. 2B shows a left end view of a spacing device according to one form of the invention;

FIG. 2C shows a right end view of a spacing device according to one form of the invention;

FIG. 2D shows an underside view of a spacing device according to one form of the invention;

FIG. 3 shows a perspective view of a spacing device according to one form of the invention, including a fastening means;

FIG. 4 shows a perspective view of a spacing device according to an alternative form of the invention;

FIG. 5A shows a side view of a spacing device according to an alternate form of the invention;

FIG. 5B shows a left end view of a spacing device according to an alternate form of the invention;

FIG. 5C shows a right end view of a spacing device according to an alternate form of the invention;

FIG. 5D shows and underside view of a spacing device according to an alternate form of the invention;

FIG. 6 shows a perspective view of a spacing device according to an alternate form of the invention, including a fastening means;

FIG. 7 shows an automobile window frame having no window glass disposed therein, which includes a plurality of spacing devices according to the invention disposed around the perimeter of the window frame;

FIG. 8 shows a side elevation view of a spacing device according to the invention in position between a glass pane and a portion of a vehicle body during placement of a window pane; and

FIG. 9 shows a perspective view of a spacing device according to the invention in position on the body portion of a motor vehicle adjacent to a window frame opening.

### DETAILED DESCRIPTION

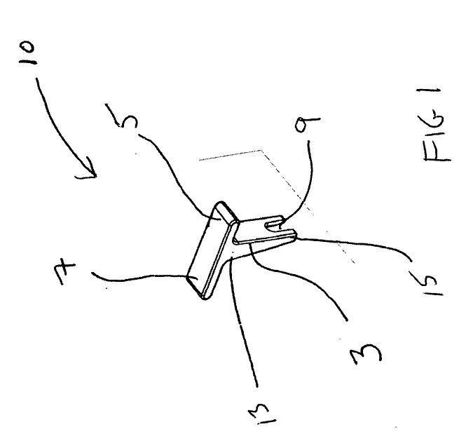

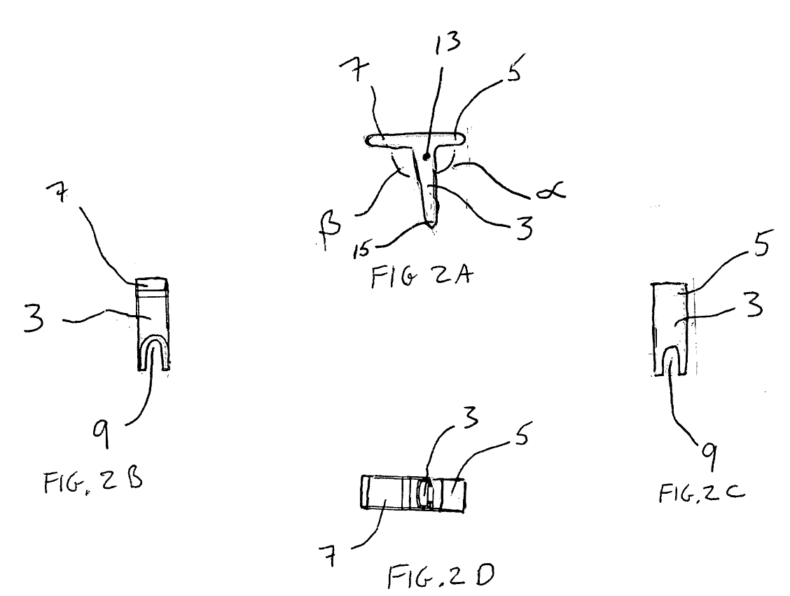

Referring to the drawings and initially to FIG. 1 there is shown a perspective view of a spacing device 10 according to one form of the invention. In this FIG. 1 is shown the anchoring portion 3, the handle end portion 7 and the spacer end portion 5. The handle end portion 7 and spacer end portion 5 collectively comprise what may be conveniently referred to as a “functionalized portion”, which is substantially linear as viewed from the side as is clear from FIG. 2A. There is also shown in FIG. 1 a means for attachment 9, which may be disposed along the length of the anchoring portion, which in this embodiment comprises a c-shaped void through the anchoring portion 3 disposed at the second end portion 15 of the anchoring portion 3. In another embodiment, the means for attachment 9 comprises a circular hole disposed through the anchoring portion 3, preferably near or at its second end portion 15. The function of the means for attachment 9 is in one embodiment to provide for affixing of an anchoring mechanism, such as a suction cup, hook-and-loop fastening means (e.g. VELCRO® fastening means), or other fastening hardware that is capable of anchoring a device according to the invention to a substrate during its use as a means for providing a set spacing during an assembly operation or process. Thus, it is seen that the first end portion 13 of the anchoring portion 3 is attached to the functionalized portion at a point along the functionalized portion which is disposed between the spacer end portion 5 and the handle end portion 7, and the second end portion 15 of the anchoring portion 3 may include a means for attachment 9 of the anchoring portion to a substrate near a location at which a desired particular spacing is provided, with the spacing being determined by the thickness of the tip or end portion of the spacer end 5, as shall become clear from what follows.

In another embodiment, the feature (void) that serves as the means for attachment 9 is not present and the second end portion 15 of the anchor portion 3 does not include any hole or void. In such embodiments, a conventional fastening means may be attached to the anchor portion, which conventional fastening means is capable of being attached to a substrate, such as an adhesive tape (including tapes which contain adhesive on either one or both sides), an adhesive, a magnet, a clamp, screws, rivets, nails, etc..

In the case of one preferred embodiment, when the means for attachment 9 is a round or c-shaped hole, channel, or groove disposed through the second end portion 15 of the anchoring portion 3, such a feature enables the device to receive a suction cup at such means for attachment, as circular suction cups are commonly known to be provided with a working face and a rear portion which comprises a circular hub which is intended to fit through holes via an interference fit for rigid support.

In another embodiment, when the anchoring portion includes a means for attachment which comprises a hole, channel, groove, etc., one or more magnets (each of any dimension) may be attached to such feature, using conventional fastening means, which magnet provides a spacing device according to the present invention to be particularly useful with ferromagnetic substrates, including without limitation sheet metals.

In yet another embodiment, the anchoring portion 3 of the spacing device does not include a hole, channel, or groove, etc., but rather has a magnet attached to an outside surface of, or embedded within the anchoring portion 3 itself (or any other portion of the spacing device 10). The former is readily accomplished by providing a conventional fastening means to fasten a magnet to the anchoring portion, including adhesives, screws, etc. In one preferred form of this embodiment, a magnet in the shape of a cylinder is employed, wherein the diameter of the magnet is greater than its cylindrical length, and the face of the anchoring portion which is intended to contact the vehicle body (in the case of automotive window glass installations) is drilled to contain a bore to a depth that is about equal to about the thickness of the magnet (cylindrical length dimension of the magnet) which is to be employed, and the magnet is inset into the bore, thus providing a spacing device having a magnetic means integral to its construction, which may be readily affixed to a ferromagnetic workpiece for providing spacing as detailed herein. Conventional means of affixing a magnet within a bore are employed, such as the use of epoxy resins, polyurethane adhesives, cyanoacrylates, and any other conventional adhesive, pins, films, covers, etc.. The magnet means may be any known magnetic material, including ceramic magnets, ALNiCo, rare earth magnets, polymer magnets, etc., and any shape of magnet is also suitable, including sheets of magnetic material having an adhesive disposed on one side of the sheet, as such materials are well known in the art and fall within magnetic means known by those skilled in the art.

In another embodiment, the entire anchoring portion 3 itself is a magnet.

In another embodiment, the entire spacing device 10 of the present invention is comprised of a magnetized material, such as a magnetized piece of steel, which has been coated with a polymer, such as PVC or a polymerized fluorinated alkene, such as including without limitation PTFE and analogs, so as to not scratch vehicle paint when employed in automotive or other end uses, where preservation of a cosmetic appearance on a painted surface is necessary.

Thus, any configuration wherein the anchoring portion 3 includes a magnet (either attached to it using conventional fastening means, or as an integral part thereof, as in the case where a magnet is disposed within the anchoring portion, or any other portion of a spacing device according to the invention, for that matter) is a suitable means for attachment of a device according to the invention to any substrate which is attracted to a magnet. Thus, the spacer end 5 of a spacing device 10 according to the invention may also include a magnet or otherwise be caused to be attracted to a magnet-attracting substrate by being itself comprised of a magnet as described above in relation to the anchoring portion 3. For purposes of this specification and the claims appended hereto, a magnetically-attractive surface is any surface to which a magnet is attracted. Such surfaces include the substantially pure metals cobalt, iron, and nickel, and alloys or combinations of any of these metals with one another or with one or more other metals of the periodic table of elements. Thus, the aforesaid embodiments including magnets are illustrative, non-limiting examples of the use of magnetic means for enabling a spacing device according to the invention to be adhered to a magnetically-attractive surface.

In FIG. 2A is shown a side view of a spacing device according to one form of the invention. In this FIG. 2A are shown the respective locations of the anchoring portion 3, spacer end 5, and handle end 7. The anchoring portion 3 includes a first end portion 13 and a second end portion 15. There is an angle alpha a which may be defined as the angle which the anchoring portion makes at its point of intersection with the spacer end 5. There is an angle beta β which may be defined as the angle which the anchoring portion makes at its point of intersection with the handle end 7. The angles α and β may each independently be any angle between about 70 and 130 degrees. These angles are the result of the contour of the anchoring portion, which is designed to provided such angles for reasons which will be understood from further consideration of the remainder of this specification. In one preferred embodiment, the angle alpha α is about 90 degrees and the angle beta β is about 100 degrees. FIG. 2B shows a left end view of a spacing device according to one form of the invention, showing the respective positions of the handle end 7, the anchoring portion 3, and the means for attachment 9. FIG. 2C shows a right end view of a spacing device according to one form of the invention depicting the respective locations of the anchoring portion 3, the spacer end 5, and the means for attachment 9 (void through the anchoring portion at its second end portion 15). FIG. 2D shows an underside view of a spacing device according to one form of the invention, showing the respective positions of the anchoring portion 3, the handle end 7, and the spacer end 5.

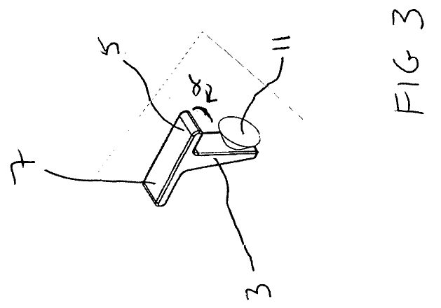

FIG. 3 shows a perspective view of a spacing device according to one form of the invention, and depicts the relative positions of the handle end 7, the spacer end 5 and the anchoring portion 3. Also shown is a suction cup 11 securely disposed within a hole through the second end portion 15 of the anchoring portion 3 with its working face oriented towards angle alpha, which in this embodiment is 90 degrees. One advantage of using a suction cup as an anchoring mechanism (the suction cup 11) disposed through a hole or other void at the second end portion 15 of the anchoring portion 3 is that the suction cup may be removed and reversed, so that its working face (the part in which a vacuum is formed by pressing against a smooth substrate) is oriented towards angle β, to confer versatility in use of a device according to the invention.

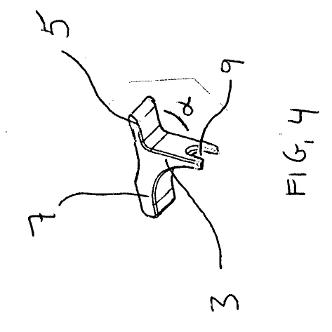

FIG. 4 shows a perspective view of a spacing device according to an alternative form of the invention, and depicts the relative positions of the anchoring portion 3, spacer end 5, handle end 7, and means for attachment 9. This embodiment shows one possible variation in design of a device according to the invention in which the angle β has been eliminated and replaced with a curved, smooth surface.

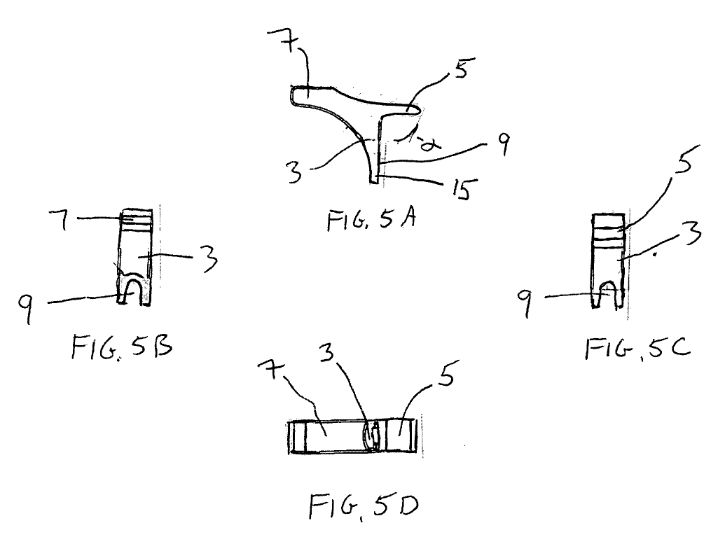

FIG. 5A shows a side view of a spacing device according to an alternate form of the invention and depicts the respective positions of the handle end 7, the spacer end 5, the anchoring portion 3, the means for attachment 9, the second end portion 15 of the anchoring portion 3, and the angle alpha α. FIG. 5B shows a left end view of a spacing device according to an alternate form of the invention, depicting the respective positions of the anchoring portion 3, the handle end 7, and the means for attachment 9. FIG. 5C shows a right end view of a spacing device according to an alternate form of the invention, depicting the respective positions of the anchoring portion 3, the spacer end 5, and the means for attachment 9. FIG. 5D shows and underside view of a spacing device according to an alternate form of the invention, illustrating the respective positions of the handle end 7, the anchoring portion 3, and the spacer end 5.

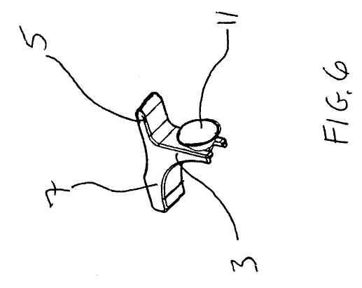

FIG. 6 shows a perspective view of a spacing device according to an alternate form of the invention, including an anchoring mechanism, which in this embodiment is a suction cup 11. Also shown are the respective positions of the handle end 7, the spacer end 5, and the anchoring portion 3.

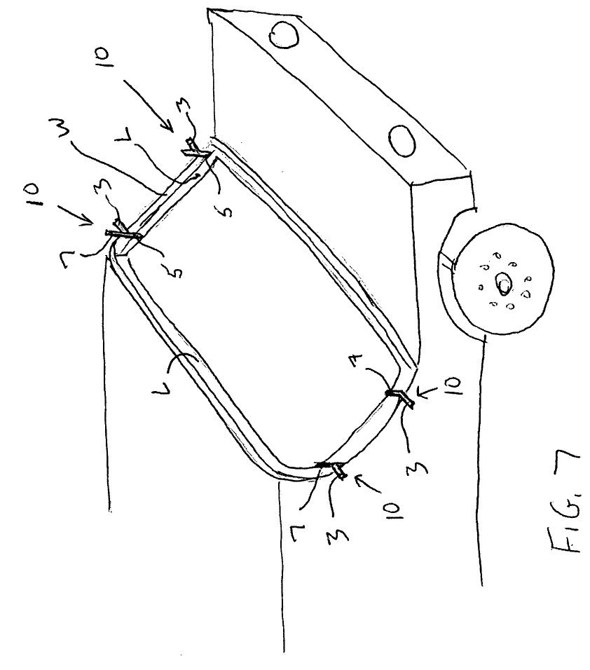

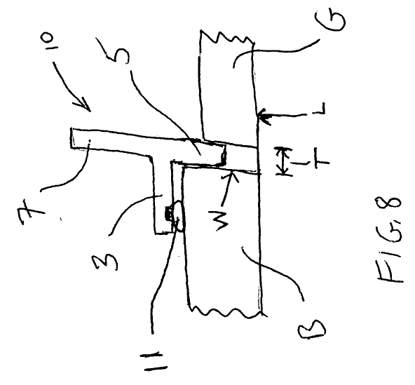

In FIG. 7 is shown an automobile window frame having no window glass disposed therein, which includes a plurality of spacing devices according to the invention disposed around the perimeter of the window frame. As is typical of window frames which are adapted to receive a pane of glass, this window frame of FIG. 7 includes a mounting surface L which runs the perimeter of the opening. It is on this mounting surface L that an adhesive substance, typically a urethane is disposed prior to fitment of the vehicle with a pane of glass. The window frame also includes a wall portion W, which also extends around the perimeter of the opening. The wall portion W is disposed vertically with respect to the flat mounting surface L, i.e., the wall W intersects the mounting surface L at an angle of about 90 degrees. Depending on the particular application, the “height” of the wall may of varying height. In this employment of the spacer devices 10 of the invention, the surface of the spacer end which is interior to angle alpha α is in substantial contact with the wall portion W, and the surface of the anchoring portion 3 which is interior to the angle alpha α is in substantial contact with the body of the vehicle just outside the perimeter of the opening into which the window is to be disposed. Fitment of a suction cup 11 in the second end portion 15 of the anchoring portion 3 enables the anchoring portion 3 and hence the spacing device 10 as a whole, to maintain its position on the vehicle's body around the window frame opening. Although only shown on the vertical pillars of the vehicle, further spacing devices 10 according to the invention may be preferably similarly attached to the vehicle's body around the window opening along the horizontal rails. Now, the benefit of the handle ends 7 of the spacing devices 10 becomes apparent in that they serve as guides to permit the workman to place the pane of glass in its desired position (after application of a suitable adhesive to the surface L) so that a uniform space exists between the wall W and the edge of the window glass, with the space being dictated by the thickness dimension T of the spacer end 5 of the spacing device 10 as clearly shown in FIG. 8, which is a side elevation view of a spacing device according to the invention in position between a glass pane and a portion of a vehicle body during placement of a window panel. This FIG. 8 shows the respective locations of the vehicle body B which comprises the wall portion W and the mounting surface L, and the edge of the pane of glass G to be installed when using a spacing device 10 according to the invention. Also shown in this FIG. 8 are the respective positions of the spacer end 5, the anchoring portion 3, and the handle end 7 of the spacing device 10, as well as the anchoring mechanism, which is a suction cup 11. Thus, it is seen that the handle end 7 serves as a guide in locating the window glass into its desired location, and that the thickness T of the spacer end 5 controls the distance of the gap between the edge of the window pane and the wall W. Through use of a plurality of spacing devices 10 of the invention, a window pane may be perfectly located in an opening, by a single man, with no chance of error, thus eliminating tearing out windshields as in the case of otherwise faulty installations in which the glass would need to be re-installed, owing to unexpected shifting during adhesive cure, as is common when employing prior art methods in aftermarket and OEM settings. After the installation is complete and the adhesive has cured, the handle end 7 serves as a convenient means for grasping the spacing device 10 and with a gentle pulling force, removing the spacing device for re-use in another job.

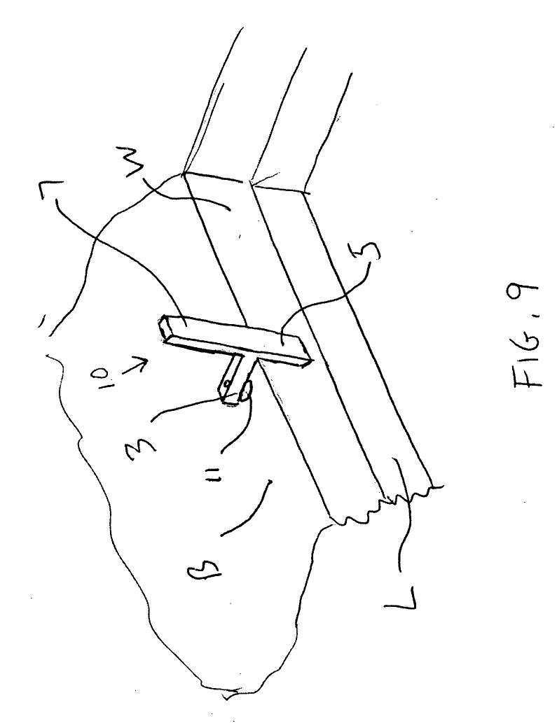

FIG. 9 shows for further clarity a perspective view of a spacing device 10 according to the invention in position on the body portion of a motor vehicle adjacent to a window frame opening. This FIG. 9 is a close-up view of the installation previously depicted in FIG. 7 showing the respective locations of the mounting surface L, the wall portion W of the window opening, the body of the vehicle B, the spacer end 5, anchoring portion 3, handle end 7, and anchoring mechanism 11, which is a suction cup.

Although it has been convenient to describe the spacing devices according to this invention in relation to the installation of a pane of glass in an opening in a motor vehicle, the spacing devices of this invention find utility in a wide range of end uses. Since motorized vehicles comprise so many components, it is natural that the spacing devices of the invention are also useful for providing uniform spacing around say, the hood of a car when it is being aligned on the vehicle. Additionally, alignment of doors and other body panels may be accomplished readily through use of the spacing devices of the invention.

The material from which a spacing device according to the present invention is fabricated may be any material selected from the group consisting of: woods, metals, metallic alloys, composites such as fiberglass, graphite composites, celluloses, polymers, including without limitation polyurethanes, polyolefins, thermoset resins, thermoplastic resins, etc., and any material which does not impair the functionality of the spacing devices. It is most preferred that the spacing devices of the invention be comprised of a polymer, with polypropylene being most preferable.

Although exemplified herein by employment in the installation of an automobile window panel in which the spacing devices according to the invention are of such size as they readily fit in one's hand, the spacing devices of the present invention are not subject to any limitations in size and spacing devices according to the invention which are as large as a common rocking chair, and even larger, are envisioned as being useful in assembling heavy equipment, such as railroad cars, oceangoing vessels, and architectural structures, and any application in which a specific desired space is desired at an interface between two components of an article of manufacture.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. This includes subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claims so modified. This also includes combination of the features and/or limitations of one or more of the independent claims with features and/or limitations of another independent claims to arrive at a modified independent claim, with the remaining dependent claims in their original text being read and applied to any independent claim so modified. Accordingly, the presently disclosed invention is intended to cover all such modifications and alterations, and is limited only by the scope of the claims which follow.

I claim:

1. A portable device useful for providing uniform spacing between two or more components of an article of manufacture during an assembly process, which portable device comprises:
a) an anchoring portion having a length dimension, a first end portion, and a second end portion;
b) a substantially-linear functionalized portion, which comprises
i) a spacer end portion having a thickness dimension; and
ii) a handle end portion,
wherein said first end portion of said anchoring portion is attached to said functionalized portion at a point along said functionalized portion which is disposed between said spacer end portion and said handle end portion, and wherein said anchoring portion includes a means for attachment of said anchoring portion to a substrate.

2. A device according to claim 1 wherein said means for attachment of said anchoring portion to a substrate is disposed along the length of said anchoring portion.

3. A device according to claim 2 wherein said means for attachment of said anchoring portion to a substrate is disposed at said second end portion of said anchoring portion.

4. A device according to claim 2 wherein said means for attachment comprises a magnet.

5. A device according to claim 1 wherein said means for attachment includes a feature selected from the group consisting of: a circular hole, a channel, a groove, and a c-shaped void.

6. A device according to claim 5 wherein said means for attachment further comprises a fastening means selected from the group consisting of: a suction cup, a magnet, an adhesive, and hook-and-loop fasteners disposed at said second end portion of said anchoring portion.

7. A device according to claim 1 wherein said anchoring portion comprises a first flat surface and wherein said spacer end portion comprises a second flat surface, wherein said first flat surface and said second flat surface intersect to provide a first angle alpha α at the intersection of said anchoring portion with said functionalized portion.

8. A device according to claim 7 wherein the angle alpha α is any angle in the range of between about 70 degrees to about 130 degrees.

9. A device according to claim 7 wherein the angle alpha α is about 90 degrees.

10. A device according to claim 1 wherein said anchoring portion comprises a first flat surface and wherein said handle end portion comprises a second flat surface, wherein said first flat surface and said second flat surface intersect to provide an angle beta β at the intersection of said anchoring portion with said functionalized portion.

11. A device according to claim 10 wherein the angle beta β is any angle in the range of between about 70 degrees to about 130 degrees.

12. A device according to claim 11 wherein the angle beta β is about 100 degrees.

13. A device according to claim 7 wherein said anchoring portion comprises a third flat surface and wherein said handle end portion comprises a fourth flat surface, wherein said third flat surface and said fourth flat surface intersect to provide an angle beta β at the intersection of said anchoring portion with said functionalized portion.

14. A device according to claim 13 wherein the angle alpha α and the angle beta β are the same angle.

15. A device according to claim 13 wherein the angle alpha α and the angle beta β are the different angles.

16. A device according to claim 13 wherein the angle alpha α and the angle beta β are each independently any angle in the range of between about 70 degrees to about 130 degrees.

17. A device according to claim 16 wherein the angle alpha α is about 90 degrees and the angle beta β is about 100 degrees.

18. A device according to claim 1 wherein said thickness dimension is any thickness between about 0.5 and about 20 millimeters.

19. A device according to claim 7 wherein said means for attachment of said anchoring portion to a substrate comprises a suction cup, and wherein the working face of the suction cup is disposed towards the angle alpha α.

20. A portable device useful for providing uniform spacing between two or more components of an article of manufacture during an assembly process, which portable device comprises:
a) an anchoring portion having a length dimension, a first end portion, and a second end portion;
b) a substantially-linear functionalized portion, which comprises
i) a spacer end portion having a thickness dimension; and
ii) a handle end portion,
wherein said first end portion of said anchoring portion is attached to said functionalized portion at a point along said functionalized portion which is disposed between said spacer end portion and said handle end portion, and wherein said portable device comprises a magnetic means for enabling said device to be adhered to a magnetically-attractive surface.
